(19) United States
(12) Patent Application Publication
(10) Pub. No.: US 2011/0208437 A1
(43) Pub. Date: Aug. 25, 2011

(54) METHOD AND APPARATUS FOR IDENTIFYING A SAFE AND EFFICACIOUS DOSING REGIMEN

(75) Inventor: Martin Teicher, Rye, NH (US)

(73) Assignee: THE MCLEAN HOSPITAL CORPORATION, BELMONT, MN (US)

(21) Appl. No.: 13/056,782

(22) PCT Filed: Jul. 31, 2009
(86) PCT No.: PCT/US09/52383

§ 371 Date: May 11, 2011

Related U.S. Application Data
(60) Provisional application No. 61/137,713, filed on Aug. 1, 2008.

(51) Int. Cl. G06F 19/00

(52) U.S. Cl. 702/19

(57) ABSTRACT

The invention features methods and systems to provide, in one test session, information on the patient's sensitivity to a probe drug for treating attentional disorders. The methods and systems of the invention can enable clinicians and consumers to ascertain how much benefit an individual would derive from treatment, what dose would be required, and the acute effect of that dose on regularity and rhythmicity of their heartbeat.

### BACKGROUND OF THE INVENTION

Attention-Deficit/Hyperactivity Disorder is a highly prevalent neuropsychiatric disorder that can respond dramatically to available pharmacological treatments. However, as the MTA multimodal treatment study revealed, children receiving conventional community care are often under-treated, and rarely receive the type of benefits the medication can provide if the drug being administered is carefully titrated. MTA Cooperative Group, Arch. Gen. Psychiatry 56:1073 (1999).

Although children, adolescents and adults often benefit markedly from treatment with stimulant medications there are prominent individual differences in sensitivity (see, for example, N. D. Volkow and J. M. Swanson Am. J. Psychiatry 160:1909 (2003)). Some patients are exquisitely sensitive and will suffer adverse effects at even moderate doses. Other individuals are much less sensitive and will derive no benefit unless they receive maximal approved dosages. Furthermore, individuals differ markedly in the rate at which they absorb and eliminate stimulants resulting in wide fluctuations in accumulation, time of onset and duration of action (see, for example, Teicher et al., J. Child Adolesc. Psychopharmacol. 16:416 (2006)). There is currently no way of predicting sensitivity and time-course in advance, and the current state-of-the-art in clinical treatment is to adjust dose by trial and error (see, for example, W. W. Dodson J. Clin. Psychol. 61:589 (2005)). However, this is a slow and laborious process that is rarely undertaken.

Previous research has shown that laboratory measures of attention are highly responsive to the effects of methylphenidate (MPH), but some studies have suggested that continuous performance tests (CPT) cannot be used for titration as CPT performance improves on doses that are too low to produce clinical benefits (see Matier et al., J. Am. Acad. Child Adolesc. Psychiatry 31:219 (1992)).

U.S. Pat. No. 6,898,455 describes a method for determining optimal dosage of a drug in ADHD subjects using a combination of behavioral measures and functional fMRI. However, this method, while capable of shortening the process of finding the appropriate dose, still requires testing subjects on multiple doses to ascertain which dose produces the best improvement in behavioral measures and regional cerebral blood volume. It is also a very costly means of identifying an appropriate dosing regimen. While such an approach would determine if patients responded best to low, intermediate or high doses, it would not provide any information on the rate at which they absorb and eliminate the drug, so one would still not know how best to time individual doses, or would know which long-acting preparation would provide the best fit given their metabolism and schedule of their daily activities.

Finally, another limitation of these procedures is the failure to provide information about potential adverse cardiovascular effects of exposure. Stimulant medications are known to increase heart rate and blood pressure, and it has recently been revealed that their use has been associated with 25 cases of sudden death, and a surprising number of hospitalizations for arrhythmias (Gardiner Harris, New York Times, Feb. 10, 2006). According to Dr. Graham of the FDA, “arrhythmia is believed to be the pathway for sudden unexplained death.”

There is a need for an inexpensive and rapid method for identifying, on an individual basis, a safe and efficacious dosing regimen for stimulant drugs, such as MPH.

### SUMMARY OF THE INVENTION

The invention features methods and systems to provide, in one test session, information on the patient's sensitivity and responsiveness to a pharmacotherapy. The methods and systems of the invention can enable clinicians and consumers to ascertain how much benefit an individual would derive from a particular drug, what dose would be required, and, optionally, the acute effect of that dose on regularity and rhythmicity of their heartbeat.

In a first aspect, the invention features a method for measuring the responsiveness of a subject to a probe drug for the treatment of an attentional disorder in the subject, the method including:

(a) testing the subject while unmedicated to produce baseline data for test MT₀;

(b) following step (a), administering a first dose of probe drug to the subject;

(c) within two hours of performing step (b), testing the subject to produce medicated data for test MT₁;

(d) following step (c), administering a second dose of probe drug to the subject;

(e) within two hours of performing step (d), testing the subject to produce medicated data for test MT₂; and

(f) analyzing the data, wherein the analysis includes scoring the baseline data and the medicated data to produce scored data; and on the basis of the scored data determining whether the symptoms of the attentional disorder are ameliorated by the probe drug,

wherein steps (a) through (e) are performed over a period of less than eight hours. In certain embodiments, steps (a) through (e) are performed in a period of between 2 hours and 8 hours, 2.5 hours and 8 hours, 3 hours and 8 hours, 3 hours and 7 hours, 3 hours and 6 hours, 2.5 hours and 5 hours, 3 hours and 5 hours, 3.5 hours and 8 hours, 3.5 hours and 7 hours, or 3.5 hours and 6 hours.

The invention further features a method for measuring the responsiveness of a subject to a probe drug for the treatment of an attentional disorder in the subject, the method including:

(a) testing the subject while unmedicated to produce baseline data for test MT₀;

(b) following step (a), administering a first dose of probe drug to the subject;

(c) within two hours of performing step (b), testing the subject to produce medicated data for test MT₁;

(d) following step (c), administering a second dose of probe drug to the subject;

(e) within two hours of performing step (d), testing the subject to produce medicated data for test MT₂; and

(f) transmitting the data to a computer for analysis, wherein the analysis includes scoring the baseline data and the medicated data to produce scored data; and on the basis of the scored data determining whether the symptoms of the attentional disorder are ameliorated by the probe drug,

wherein steps (a) through (e) are performed over a period of less than eight hours. In certain embodiments, steps (a) through (e) are performed in a period of between 2 hours and 8 hours, 2.5 hours and 8 hours, 3 hours and 8 hours, 3 hours and 7 hours, 3 hours and 6 hours, 2.5 hours and 5 hours, 3 hours and 5 hours, 3.5 hours and 8 hours, 3.5 hours and 7 hours, or 3.5 hours and 6 hours.

In a related aspect the invention features a method for measuring the responsiveness of a subject to a probe drug for the treatment of an attentional disorder in the subject, the method including (i) providing data having been collected by the steps of:

(a) testing the subject while unmedicated to produce baseline data for test MT₀;

(b) following step (a), administering a first dose of probe drug to the subject;

(c) within two hours of performing step (b), testing the subject to produce medicated data for test MT₁;

(d) following step (c), administering a second dose of probe drug to the subject; and

(e) within two hours of performing step (d), testing the subject to produce medicated data for test MT₂, wherein steps (a) through (e) are performed over a period of less than eight hours; and

(ii) performing an analysis, the analysis including scoring the baseline data and the medicated data to produce scored data, and on the basis of the scored data determining whether the symptoms of the attentional disorder are ameliorated by the probe drug.

In one embodiment of the above methods, (i) step (c) is performed within 20 minutes, 30 minutes, 45 minutes, 1 hour, 75 minutes, or 90 minutes of performing step (b); (ii) step (e) is performed within 20 minutes, 30 minutes, 45 minutes, 1 hour, 75 minutes, or 90 minutes of performing step (d); and (iii) steps (a) through (e) are performed over a period of less than 7.5 hours, 7 hours, 6.5 hours, 6 hours, 5.5 hours, 5 hours, 4.5 hours, 4 hours, 3.5 hours, or 3 hours. In certain embodiments, steps (a) through (e) are performed in a period of between 2 hours and 8 hours, 2.5 hours and 8 hours, 3 hours and 8 hours, 3 hours and 7 hours, 3 hours and 6 hours, 2.5 hours and 5 hours, 3 hours and 5 hours, 3.5 hours and 8 hours, 3.5 hours and 7 hours, or 3.5 hours and 6 hours.

Step (e) can be performed twice within 0.5 hours, 0.75 hours, 1.0 hours, 1.25 hours, 1.5 hours, 1.75 hours, or 2 hours of performing step (d) to produce medicated data for tests MT_{2A} and MT_{2B}.

In other embodiments, the above methods include the steps of (d2) following step (e), administering a third dose of probe drug to the subject; and (e2) within two hours of completing step (d2), testing the subject to produce medicated data for test MT₃. In a particular embodiment, step (c) is performed within 20 minutes, 30 minutes, 45 minutes, 1 hour, 75 minutes, or 90 minutes of performing step (b); step (e) is performed within 20 minutes, 30 minutes, 45 minutes, 1 hour, 75 minutes, or 90 minutes of performing step (d); and steps (a) through (e2) are performed over a period of less than 7.5 hours, 7 hours, 6.5 hours, 6 hours, 5.5 hours, 5 hours, 4.5 hours, 4 hours, or 3.5 hours. Step (e2) can be performed twice within two hours of performing step (d2) to produce medicated data for tests MT_{3A} and MT_{3B}.

In still other embodiments, the above methods include the steps of (e3) following step (e2), administering a fourth dose of probe drug to the subject; and (d3) within one hour of completing step (e3), testing the subject to produce a medicated data for test MT₄; wherein steps (a) through (d3) are performed over a period of less than 7.5 hours, 7 hours, 6.5 hours, 6 hours, 5.5 hours, 5 hours, 4.5 hours, 4 hours, 3.5 hours, or 3 hours. Step (d3) can be performed twice within two hours of performing step (e3) to produce medicated data for tests MT_{4A} and MT_{4B}.

The invention further features a method for measuring the responsiveness of a subject to a probe drug for the treatment of an attentional disorder in the subject, the method including:

(i) testing the subject while unmedicated to produce baseline data for test MT₀;

(ii) following step (i), administering a first dose of probe drug to the subject;

(iii) 15 to 45 minutes following the performance of step (ii), testing the subject to produce medicated data for test MT_{1A};

(iv) 1 to 3 hours following the performance of step (iii), testing the subject to produce medicated data for test MT_{1B}; and

(v) analyzing the data, wherein the analysis includes scoring the baseline data and the medicated data to produce scored data; and on the basis of the scored data determining whether the symptoms of the attentional disorder are ameliorated by the probe drug. In certain embodiments, step (iii) is performed 15 minutes to 40 minutes, 20 minutes to 45 minutes, 20 minutes to 40 minutes, 15 minutes to 1 hour, 20 minutes to 1 hour, or 25 minutes to 45 minutes following the performance of step (ii); and step (iv) is performed 45 minutes to 4 hours, 45 minutes to 3 hours, 45 minutes to 2 hours, 45 minutes to 1 hour, 1 hour to 3 hours, 1 hour to 2 hours, 1 hour to 1.5 hours, 1.5 hours to 3 hours, or 1.5 hours to 2 hours following the performance of step (iii).

The invention also features a method for measuring the responsiveness of a subject to a probe drug for the treatment of an attentional disorder in the subject, the method including:

(i) testing the subject while unmedicated to produce baseline data for test MT₀;

(ii) following step (i), administering a first dose of probe drug to the subject;

(iii) 15 to 45 minutes following the performance of step (ii), testing the subject to produce medicated data for test MT_{1A};

(iv) 1 to 3 hours following the performance of step (iii), testing the subject to produce medicated data for test MT_{1B}; and

(v) transmitting the data to a computer for analysis, wherein the analysis includes scoring the baseline data and the medicated data to produce scored data; and on the basis of the scored data determining whether the symptoms of the attentional disorder are ameliorated by the probe drug. In certain embodiments, step (iii) is performed 15 minutes to 40 minutes, 20 minutes to 45 minutes, 20 minutes to 40 minutes, 15 minutes to 1 hour, 20 minutes to 1 hour, or 25 minutes to 45 minutes following the performance of step (ii); and step (iv) is performed 45 minutes to 4 hours, 45 minutes to 3 hours, 45 minutes to 2 hours, 45 minutes to 1 hour, 1 hour to 3 hours, 1 hour to 2 hours, 1 hour to 1.5 hours, 1.5 hours to 3 hours, or 1.5 hours to 2 hours following the performance of step (iii).

The features a method for measuring the responsiveness of a subject to a probe drug for the treatment of an attentional disorder in the subject, the method including (i) providing data having been collected by the steps of:

(a) testing the subject while unmedicated to produce baseline data for test MT₀;

(b) following step (a), administering a first dose of probe drug to the subject;

(c) 15 to 45 minutes following the performance of step (b), testing the subject to produce medicated data for test MT_{1A}; and

(d) 1 to 3 hours following the performance of step (c), testing the subject to produce medicated data for test MT_{1B},

wherein steps (a) through (d) are performed over a period of less than five hours;

and (ii) performing an analysis, the analysis including scoring the baseline data and the medicated data to produce scored data, and on the basis of the scored data determining whether the symptoms of the attentional disorder are ameliorated by the probe drug. In certain embodiments, step (c) is performed 15 minutes to 40 minutes, 20 minutes to 45 minutes, 20 minutes to 40 minutes, 15 minutes to 1 hour, 20 minutes to 1 hour, or 25 minutes to 45 minutes following the performance of step (b); and step (d) is performed 45 minutes to 4 hours, 45 minutes to 3 hours, 45 minutes to 2 hours, 45 minutes to 1 hour, 1 hour to 3 hours, 1 hour to 2 hours, 1 hour to 1.5 hours, 1.5 hours to 3 hours, or 1.5 hours to 2 hours following the performance of step (c).

The further features a method for measuring the responsiveness of a subject to a probe drug for the treatment of an attentional disorder in the subject, the method including:

(i) testing the subject while unmedicated to produce baseline data for test MT₀;

(ii) following step (i), administering a first dose of probe drug to the subject;

(iii) 15 minutes to 4 hours following the performance of step (ii), testing the subject to produce medicated data for test MT₁; and

(iv) analyzing the data, wherein the analysis includes scoring the baseline data and the medicated data to produce scored data; and on the basis of the scored data, the amount of probe drug administered, the timing of the administering, the timing of the testing, and a population-based PK model for the probe drug, calculating a predicted response profile for the probe drug in the subject. In certain embodiments, step (iii) is performed 15 minutes to 3 hours, 20 minutes to 3 hours, 30 minutes to 3 hours, 45 minutes to 4 hours, 45 minutes to 3 hours, 30 minutes to 2 hours, 45 minutes to 2 hours, or 1 hour to 4 hours following the performance of step (ii).

The invention also features a method for measuring the responsiveness of a subject to a probe drug for the treatment of an attentional disorder in the subject, the method including:

(i) testing the subject while unmedicated to produce baseline data for test MT₀;

(ii) following step (i), administering a first dose of probe drug to the subject;

(iii) 15 minutes to 4 hours following the performance of step (ii), testing the subject to produce medicated data for test MT₁; and

(iv) transmitting the data to a computer for analysis, wherein the analysis includes scoring the baseline data and the medicated data to produce scored data; and on the basis of the scored data, the amount of probe drug administered, the timing of the administering, the timing of the testing, and a population-based PK model for the probe drug, calculating a predicted response profile for the probe drug in the subject. In certain embodiments, step (iii) is performed 15 minutes to 3 hours, 20 minutes to 3 hours, 30 minutes to 3 hours, 45 minutes to 4 hours, 45 minutes to 3 hours, 30 minutes to 2 hours, 45 minutes to 2 hours, or 1 hour to 4 hours following the performance of step (ii).

The invention features a method for measuring the responsiveness of a subject to a probe drug for the treatment of an attentional disorder in the subject, the method including (i) providing data having been collected by the steps of:

(a) testing the subject while unmedicated to produce baseline data for test MT₀;

(b) following step (a), administering a first dose of probe drug to the subject; and

(c) 15 minutes to 4 hours following the performance of step (b), testing the subject to produce medicated data for test MT₁; and (ii) performing an analysis, the analysis including scoring the baseline data and the medicated data to produce scored data, and on the basis of the scored data, the amount of probe drug administered, the timing of the administering, the timing of the testing, and a population-based PK model for the probe drug, calculating a predicted response profile for the probe drug in the subject. In certain embodiments, step (c) is performed 15 minutes to 3 hours, 20 minutes to 3 hours, 30 minutes to 3 hours, 45 minutes to 4 hours, 45 minutes to 3 hours, 30 minutes to 2 hours, 45 minutes to 2 hours, or 1 hour to 4 hours following the performance of step (b).

In certain embodiments of the rapid titration methods of the invention, the probe drug is a stimulant, such as methylphenidate or amphetamine. In other embodiments, the probe drug is a nonstimulant, such as a tricyclic antidepressant, atomoxetine, bupropion, modafinil, guanfacine, or clonidine. Any stimulant or nonstimulant medication recited herein can be used in the methods of the invention.

For example, where the subject is an adult, the first dose can include from 5 to 15 mg of methylphenidate, the second dose can include from 7.5 to 12.5 mg of methylphenidate, and the third dose can include from 2.5 to 12.5 mg of methylphenidate. In a particular embodiment, the first dose includes from 4 to 30 mg, 4 to 20 mg, 4 to 12 mg, 6 to 15 mg, 6 to 12 mg, 7 to 15 mg, 7 to 12 mg, 8 to 20 mg, 8 to 15 mg, 8 to 12 mg, or 10 to 15 mg of methylphenidate, the second dose includes from 7 to 11 mg, 7.5 to 15 mg, 8 to 12.5 mg, 8 to 11 mg, 8.5 to 12.5 mg, 9 to 12.5 mg, or 9 to 11 mg of methylphenidate, and the third dose includes from 2.5 to 8 mg, 2.5 to 6.5 mg, 2.5 to 5.5 mg, 3.5 to 8.5 mg, 3.5 to 6.5 mg, 4 to 6.5 mg, 4.5 to 6.5 mg, or 4.5 to 6.5 mg of methylphenidate. Where the subject is a child, the first dose includes from 2.5 to 12.5 mg, 2.5 to 10.5 mg, 3.5 to 10.5 mg, 4.5 to 9.5 mg, 4.5 to 8.5 mg, 3.5 to 7.5 mg, 5 to 7.5 mg, 5 to 10.5 mg, or 3.5 to 5.5 mg of methylphenidate, the second dose includes from 5 to 7.5 mg, 5.5 to 7.5 mg, 4 to 8 mg, 4 to 6.5 mg, 4.5 to 9.5 mg, 5.5 to 7.5 mg, 4.5 to 7.5 mg, 4 to 7 mg, or 3 to 9 mg of methylphenidate, and the third dose includes from 1.5 to 7.5 mg, 1 to 9 mg, 1.5 to 7 mg, 1.5 to 6.5 mg, 2.5 to 9 mg, 2.5 to 7.5 mg, 3.5 to 9 mg, 3.5 to 7.5 mg, 4.5 to 9 mg, or 4.5 to 7.5 mg of methylphenidate. In certain embodiments where the subject is a child, methylphenidate (first dose, second dose, and/or third dose) is given in a dose range of from 0.1 to 0.7 mg/kg, 0.1 to 1.0 mg/kg, 0.3 to 0.7 mg/kg, 0.1 to 0.5 mg/kg, 0.4 to 0.7 mg/kg, or 0.1 to 0.3 mg/kg.

In certain embodiments, the probe drug is an amphetamine. For example, where the subject is an adult, the first dose includes from 2.5 to 20 mg, 2.5 to 7.5 mg, 3.5 to 9 mg, 3.5 to 7.5 mg, 4.5 to 9 mg, 4.5 to 7.5 mg, 5.5 to 9 mg, 5.5 to 7.5 mg, or 2.5 to 5.5 mg, of dextroamphetamine, the second dose includes from 3.75 to 6.25 mg, 4.25 to 8 mg, 4.25 to 6.25 mg, 4.75 to 8 mg, 4.75 to 6.25 mg, 5.75 to 8 mg, 3.25 to 5.25 mg, or 3.25 to 7.25 mg of dextroamphetamine, and the third dose includes from 3.75 to 6.25 mg, 4.25 to 8 mg, 4.25 to 6.25 mg, 4.75 to 8 mg, 4.75 to 6.25 mg, 5.75 to 8 mg, 3.25 to 5.25 mg, or 3.25 to 7.25 mg of dextroamphetamine. Where the subject is a child, the first dose includes from 1.25 to 6.25 mg, 2.25 to 8 mg, 2.25 to 6.25 mg, 3.25 to 8 mg, 3.25 to 6.25 mg, 1.25 to 5.25 mg, 4.25 to 7.25 mg, or 4.25 to 6.25 mg of dextroamphetamine, the second dose includes from 2.5 to 3.75 mg, 2.75 to 4.25 mg, 2.75 to 3.75 mg, 2.25 to 4.25 mg, 2.25 to 3.75 mg, 3.0 to 4.5 mg, 3.0 to 4.25 mg, 3.0 to 4.0 mg, 2.5 to 3.25 mg of dextroamphetamine, and the third dose includes from 0.75 to 3.75 mg, 0.75 to 6 mg, 0.75 to 3.75 mg, 1.25 to 6 mg, 1.25 to 3.75 mg, 1.75 to 6 mg, 1.75 to 3.75 mg, 2.25 to 6 mg, 2.25 to 3.75 mg, 0.5 to 6 mg, or 0.5 to 3.75 mg of dextroamphetamine. In certain embodiments where the subject is a child, dextroamphetamine (first dose, second dose, and/or third dose) is given in a dose range of from 0.05 to 0.4 mg/kg, 0.05 to 0.6 mg/kg, 0.05 to 0.2 mg/kg, 0.1 to 0.4 mg/kg, 0.1 to 0.6 mg/kg, 0.15 to 0.4 mg/kg, 0.15 to 0.6 mg/kg, or 0.1 to 0.3 mg/kg.

In one embodiment of any of the above methods, the analysis further includes any one or more of identifying the subject as a non-responder or a responder, calculating a predicted response profile for a dosing regimen of the probe drug in the subject, calculating the predicted degree of improvement in a symptom of the attentional disorder for the subject when receiving the dosing regimen in comparison to the subject when unmedicated and determining the relative degree of efficacy for two or more dosing regimens of the probe drug in the subject.

In certain embodiments, the methods of the invention further include (i) analyzing the heart rate of the subject to determine whether the probe drug places the subject at an increased risk of an adverse cardiovascular event, or (ii) analyzing solicited responses from the subject to determine whether the probe drug places the subject at an increased risk of nervousness, agitation, or loss of appetite. In such instances, the analysis can further include estimating the severity of the side effects for the subject on a particular dosing regimen of the probe drug.

The testing can include, for example, measuring the activity of the subject using an infrared motion analysis system by tracking the movements of the subject's head, leg, or foot using a camera. Alternatively, the testing can include collecting data from an attentional test while tracking the movements. The analysis of the attentional data can include assessing the fluctuation in attentional states of the subject. In certain embodiments, the testing includes both monitoring motor activity and collecting data from an attentional test.

In a related aspect, the invention features a system for measuring the responsiveness of a subject to a probe drug for the treatment of an attentional disorder, the system including:

(i) a user interface for communicating the amounts of probe drug administered to the subject; the timing of the doses; and the timing of motor activity tests;

(ii) a camera for tracking the movements of the subject's head, leg, or foot to produce motor activity data; and

(iii) an output component and program configured to transmit information to a computer for analysis, the information including the amounts of probe drug administered to the subject; the timing of the doses; the timing of the motor activity tests; and the motor activity data.

The invention also features a system for measuring the responsiveness of a subject to a probe drug for the treatment of an attentional disorder, the system including (i) a monitor for generating visual images or a speaker for generating sounds; (ii) a device that is controllable by a subject; and (iii) a program for storing or transmitting information about the instances of device activation by the subject in response to the images or the sounds to a computer for analysis, the information including attention data and the timing of the collection of the attention data.

The invention further features a system for measuring the responsiveness of a subject to a probe drug for the treatment of an attentional disorder, the system including:

(i) an input component configured to receive information including the amounts of probe drug administered to the subject; the timing of the doses; and the timing of subject testing, and test data; and

(ii) a processor provided with a computer program for (a) scoring the test data to produce scored data, and (b) on the basis of the scored data, determining whether the subject is responsive to the probe drug.

In certain embodiments, test data is either motor activity data or attentional data. Thus, the system may further include a processor provided with a computer program for (a) scoring the attention data to produce scored attention data, and (b) on the basis of the scored attention data, determining whether the subject is responsive to the probe drug. Step (b) can include assessing the fluctuation in attentional states of the subject. Alternatively, the system may further include a processor provided with a computer program for (a) scoring the motor activity data to produce scored motor activity data, and (b) on the basis of the scored motor activity data, determining whether the subject is responsive to the probe drug.

In one embodiment of any of the above system, the analysis further includes any one or more of a processor provided with a program for identifying the subject as a non-responder or a responder, a processor provided with a program for calculating a predicted response profile for a dosing regimen of the probe drug in the subject, a processor provided with a program for calculating the predicted degree of improvement in a symptom of an attentional disorder for the subject when receiving the dosing regimen in comparison to the subject when unmedicated, and a processor provided with a program for determining the relative degree of efficacy for two or more dosing regimens of the probe drug in the subject.

In any of the above systems of the invention, the system may include a heart rate monitor for collecting heart rate data and a program for storing or transmitting the heart rate data to a computer for analysis. The system may further include a processor provided with a program for analyzing heart rate data to determine whether the subject has an increased risk of an adverse cardiovascular event after administration of a probe drug.

In any of the above methods or systems, the attentional disorder can be, without limitation, ADD, ADHD, or Hyperkinetic Disorder.

In a particular embodiment of any of the above methods or systems, the scored data includes a metric extracted from an attentional test and selected from accuracy, errors of omission, errors of commission, latency, standard deviation of latency, coefficient of variation of latency, number of attention shifts, percent time spent impulsive state, percent time spent in distracted state, percent time spent in random state, percent time spent in minimal response state, percent time spent in contrary response state, percent time spent in attentive state, accuracy-adjusted latency, and composites thereof. Using the methods of the invention, the unmedicated and medicated results for one or more attention metrics, or a composite thereof, for a subject are compared to determine what amount of medication, if any, brings the metric, or a composite thereof, into a normal range given the subject's gender, age or grade.

In another embodiment of any of the above methods or systems, the scored data includes a metric extracted from a motor activity test and selected from immobility time of head, area of head movements, temporal scaling exponent, displacement, spatial scaling exponent, number of microevents, area of right and left shin movements, rl_mic, rl_disp, and composites thereof. Using the methods of the invention, the unmedicated and medicated results for one or more motor activity metrics, or a composite thereof, for a subject are compared to determine what amount of medication, if any, brings the metric, or a composite thereof, into a normal range given the subject's gender, age or grade.

In one embodiment of any of the above methods or systems, the scored data includes a composite of metrics extracted from an attentional test and metrics extracted from a motor activity test. The metrics can be any of the metrics described herein. Using the methods of the invention, the unmedicated and medicated results for one or more metrics, or a composite thereof, for a subject are compared to determine what amount of medication, if any, brings the metric, or a composite thereof, into a normal range given the subject's gender, age or grade.

As used herein, the term “MT₀” refers to a test, or the results or analysis thereof, administered to an unmedicated subject (also referred to herein as “baseline” results or data).

As used herein, the term “MTₙ” refers to a test, or the results or analysis thereof, administered to a medicated subject who has received n probe doses of medicament. Where sequential tests are performed prior to the next dosing, the data are further identified by letter to indicate the number of tests performed prior to the next dosing (e.g., three tests taken after probe dose number 3 and prior to probe dose number 4 are indicated as tests MT_{3A}, MT_{3B}, and MT_{3C}, respectively).

As used herein, the term “attentional disorder” refers to a condition characterized by inattention, over-activity, and/or impulsiveness. The methods and systems of the invention can be useful for the identifying a dosing regimen for the treatment of attentional disorders, such as, without limitation, Attention Deficit Hyperactivity Disorder, Attention Deficit Disorder, and Hyperkinetic Disorder. Attention Deficit Hyperactivity Disorder, which is also referred to in the literature as Attention Deficit Disorder/Hyperactivity Syndrome (ADD/HS), is a condition (or group of conditions) characterized by impulsiveness, distractibility, inappropriate behavior in social situations and hyperactivity. ADD/HS is reported to have a prevalence of 3-9% in children (Anderson et al., Archives of General Psychiatry 44:69 (1987); Bird et al., Archives of General Psychiatry 45:1120 (1988); and Szatmari et al., J. Child Psychol. Psychiatry 30:219 (1989)), and upwards of 18% as reported in recent systemic reviews (Rowland et al., Ment. Retard. Dev. Disabil. Res. Rev. 8:162 (2002)). Symptoms of ADHD often diminish with age, but about 65% of individuals with ADHD continue to experience significant symptoms in adulthood (Faraone et al., Psychol. Med. 36:159 (2006)). This disorder can impair social function, learning and/or development and is therefore now recognized as a serious problem. It is further recognized that many children with ADHD go on to develop other comorbid conditions or social problems in adulthood. In clinical terms ADHD is diagnosed if any one of the three main clinical features of inattention, over-activity and impulsiveness, persists in two or more situations, e.g., in both a home and school environment (American Psychiatric Association. Diagnostic and Statistical Manual of Mental Disorders, Fourth Edition (DSM-IV) Wash. D.C.; American Psychiatric Association, 1994). A particularly severe form of ADHD is termed Hyperkinetic Disorder. In Britain, this diagnosis is made only if all three of the main clinical features (inattention, over-activity and impulsiveness) have been present from an early age, persist in more than one situation (e.g., home and school) and impair function (see The ICD-10 Classification of Mental and Behavioural Disorders: Diagnostic Criteria for Research, Geneva: World Health Organisation, 1993: 155-7). Reports indicate that 1.4% of children suffer from hyperkinetic disorder (Meltzer H, Gatward R, Goodman R, Ford T. Mental Health of Children and Adolescents in Great Britain. ONS. London: The Stationery Office; 2000).

As used herein, the term “probe drug” refers to specific pharmaceutically active ingredients found in medications useful for the treatment of an attentional disorder and which can be used in the rapid titration protocol of the invention. Probe drugs which can be used in the methods of the invention have a rapid onset of action (i.e., less than 2 hours post administration when formulated for immediate release) and limited duration of action (i.e., a half-life of less than 12 hours). Probe drugs which can be used in the methods of the invention include, without limitation, methylphenidate, amphetamines, some tricyclic antidepressants, atomoxetine, bupropion, modafinil, and alpha2 agonists, such as guanfacine and clonidine.

As used herein, the term “predicted response profile” refers to a calculation of how the subject's test results are predicted to change in response to a particular dosing regimen for a particular probe drug. The predicted response profile can be calculated using the test data obtained from the rapid titration protocol of the invention and the timing of the probe doses. First, any changes in the test results obtained during the rapid titration protocol are assessed as a function of the doses of probe drug administered using a population-based PK model to estimate degree of probe drug accumulation at each test point during the protocol. Second, the correlation between probe drug accumulation and observed changes in test data is established for the subject. Third, a population-based PK model to indicate the dosage of different commercial preparations required to produce a minimal, moderate or marked improvement at specific times (such as tmax) based upon the correlation established for the subject. The predicted response profile may be reported as a predicted Clinical Global Impression (CGI) Scale for Improvement of the subject in response to a particular dosing regimen for a particular probe drug. The CGI scale is a 7 point scale with the following anchors: 1-very much improved, 2-much improved, 3-minimally improved, 4-unchanged, 5-minimally worse, 6-much worse, 7-very much worse. A non-responder falls into the range of minimally improved to very much worse on optimal dose, or has severe side-effects that outweigh benefits of being much improved or very much improved. For example, the response to the probe dose can be measured in percent change in motor activity parameters, and the prediction of response to a long acting methylphenidate preparation (not the probe) would be estimated in CGI terms (from 1-7).

As used herein, the term “superior predicted response profile” refers to a predicted response profile for a treatment regimen that, using the methods of the invention, is predicted to be superior in efficacy in a particular subject in comparison to other treatment regimens. A superior predicted response profile is obtained by comparing the predicted response profile for several different treatment regimens to identify the which regimens are predicted to be superior in providing the subject with relief from the symptoms of an attentional disorder.

As used herein, the term “non-responder” refers to a subject whose predicted response profile indicates that they would be unchanged (CGI 4), minimally worse (CGI 5), much worse (CGI 6), or very much worse (CGI 7) on any reasonable dose of pharmaceutical preparations with the same active ingredient as the probe. A non-responder is also an individual who experiences significant side-effects on the probe agent that would outweigh predicted benefits.

As used herein, the term “responder” refers to a subject whose predicted response profile indicates that they would be very much (CGI 1), much (CGI 2), or at least minimally improved (CGI 3) by a commercial preparation containing the probe agent as an active ingredient, at a reasonable (clinically justifiable) dose.

As used herein, the term “predicted degree of improvement” the degree of expected clinical response (improvement or worsening) that an individual would be expected to experience in their everyday life based on their test performance (e.g., motor activity change, attention state change) while on a particular treatment regimen. The predicted degree of improvement is determined by comparing the predicted response profile for the regimen to the motor activity for the unmedicated subject.

As used herein, the term “relative degree of efficacy” refers to a comparison of the predicted response profiles for two or more treatment regimens of a probe drug in a particular subject.

As used herein, the terms “test” and “testing” refer to motor activity tests and testing and/or attentional tests and testing. Using the methods of the invention, the unmedicated and medicated test results for a subject are compared to determine what amount of medication, if any, brings the test results into a normal range given the subject's gender, age or grade.

As used herein, the term “motor activity test” refers to a test in which the motor activity of a subject is monitored. For example, movement patterns can be analyzed using procedures described by Teicher et al., J. Am. Acad. Child Adolsec. Psychiatry 35:334 (1996). Changes in motor activity can be a measure of the efficacy of a particular drug for the treatment of an attentional disorder (see, for example, PCT Publication No. WO07/114901).

As used herein, the term “attentional test” refers to a cognitive control task which measures the ability to suppress inappropriate thoughts and actions in favor of more appropriate ones. Such tasks include stop signal, Go/No-Go, and Stroop paradigm tasks (see, for example, Casey et al., Am J Psychiatry 164:11 (2007)). In certain embodiments, the attentional test is a continuous performance test (i.e., a CPT test, such as a visual or audio test, see PCT Publication No. WO 2006/023964), given either simultaneously or concurrently with the motor activity monitoring. In some instances, the rapid titration protocol of the invention includes assessing the fluctuation in attentional states of the subject from the CPT test data. Other attentional measures (i.e., attentional data), such as changes in response latency, response variability, adjusted latency, or adjusted accuracy (see, e.g., U.S. Patent Publication No. 20030233032) are known in the art and may also be used.

As used herein, “assessing the fluctuation in attentional states” refers to measuring the fluctuation in the attentional state of the subject during a test period. The methodology for making such a measurement is described in U.S. Pat. No. 6,685,652, incorporated herein by reference. Briefly, during an attentional test, such as a CPT test or another cognitive control task, the subject's responses are scored. Rather than measure the average attentional state of the subject, the data for a single test is divided into segments and each segment is separately scored to determine how the attentional state of the subject fluctuates during the single test (i.e., the amount of time spent in a particular attentional state (attentive, impulsive, distracted) can be calculated along with the number of shifts in the attentional state of the subject during the test period.

As used herein, “accuracy” refers to the percentage of correct responses during a subject's attentional test.

As used herein, “errors of omission” refers to the percentage of missed targets during a subject's attentional test. Errors of omission is a measure of inattention.

As used herein, “errors of commission” refers to the percentage of incorrect responses to non-targets during a subject's attentional test. Errors of commission is a measure of impulsivity.

As used herein, “latency” refers to the average amount of time to respond correctly during a subject's attentional test (speed).

As used herein, “standard deviation of latency” or “variability in response latency” refers to the standard deviation in the average amount of time to respond correctly during a subject's attentional test (standard deviation in speed).

As used herein, “coefficient of variation of latency” refers to a normalized measure of response time variation (coefficient of variation of latency=(standard deviation of latency)/latency).

As used herein, “number of attention shifts” or “number of shifts” refers to the number of shifts in the attentional state of the subject observed during an attentional test. The number of shifts is a measure of how many times a change in behavioral states occurs over the course of a test.

As used herein, “percent time spent impulsive state” refers to the percent of blocks when the subject performed better than chance but made a significant number of commission errors. This metric is derived from the shifts in attentional state analysis of the subject's attentional test.

As used herein, “percent time spent in distracted state” refers to the percent of blocks when the subject performed better than chance but missed a significant number of targets. This metric is derived from the shifts in attentional state analysis of the subject's attentional test.

As used herein, “percent time spent in random state” refers to the percent of blocks when the subject performed no better than predicted by random chance. This metric is derived from the shifts in attentional state analysis of the subject's attentional test.

As used herein, “percent time spent in minimal response state” refers to the percent of blocks when the subject performed no better than predicted by random chance and made few responses. This metric is derived from the shifts in attentional state analysis of the subject's attentional test.

As used herein, “percent time spent in contrary response state” refers to the percent of blocks when the subject performed worse than predicted by random chance. This metric is derived from the shifts in attentional state analysis of the subject's attentional test.

As used herein, “percent time spent in attentive state” or “on-task” refers to the percent of blocks in which the subject performed with very high level of accuracy. This metric is derived from the shifts in attentional state analysis of the subject's attentional test.

As used herein, “accuracy-adjusted latency” refers to a composite score based upon latency, the variation in response time to the correct target during a subject's attentional test, and accuracy, the correct responses during a subject's attentional test. Accuracy-adjusted latency can be calculated as described in U.S. Patent Publication No. 20030233032, published Dec. 18, 2003, and incorporated herein by reference.

As used herein, “immobility time of head” refers to the average amount of time spent sitting still according to data generated using the reflector placed on the subject's head.

As used herein, “area of head movements” refers to the total area covered by the marker's path according to data generated using the reflector placed on the subject's head.

As used herein, “temporal scaling exponent” refers to the pattern of movement in time according to data generated using the reflector placed on the subject's head. The temporal scaling exponent is calculated from the log-log reciprocal stochastic relationship between the frequency of microevents and their duration. For a two-process model in which a marker is either in motion or immobile, stochastic theory dictates that there will be a greater number of brief periods of immobility than long periods of immobility (though not necessarily a greater amount of time). The log-log relationship provides a robust measure of relative activity versus inactivity. Lower values indicate lack of movement, while higher values indicate incessant movement.

As used herein, “displacement” refers to the total distance moved by the marker according to data generated using the reflector placed on the subject's head.

As used herein, “spatial scaling exponent” refers to the complexity of the marker movement path and is calculated by ascertaining the logarithmic rate of information decay at progressively lower levels of temporal resolution. Lower values indicate linear or back-and-forth movement, while higher values indicate more complex movement.

As used herein, “number of microevents” refers to the number of position changes according to data generated using the reflector placed on the subject's head. A new microevent begins whenever the marker moves 1.0 mm (or some other prespecified distance) or more from the location of the previous microevent, and it is defined by its position and duration. Microevents should be defined first, as all the other movement measures are derived from the microevent measures.

As used herein, “area of right and left shin movements” refers to the average of the right and left total area covered by the marker's path according to data generated using reflectors placed on the subject's right and left shins.

As used herein, “rl_mic” refers to the average of the right and left number of position changes according to data generated using reflectors placed on the subject's right and left shins. A new microevent begins whenever the marker moves 1.0 mm (or some other prespecified distance) or more from the location of the previous microevent, and it is defined by its position and duration. Microevents should be defined first, as all the other movement measures are derived from the microevent measures.

As used herein, “rl_disp” refers to the average of the right and left total distance moved by the marker according to data generated using reflectors placed on the subject's right and left shins.

Other features and advantages of the invention will be apparent from the following detailed description and the claims.

### BRIEF DESCRIPTION OF THE DRAWINGS

FIG. 1 is a picture depicting McLean Motion and Attention Test (M-MAT™), which is cleared by the FDA for assessment of the core symptoms of ADHD—hyperactivity, impulsivity and inattention. The M-MAT™ test results provide precise quantitative assessment of the capacity of children, adolescents and adults to pay attention to visual stimuli while inhibiting their locomotor activity and controlling their urge to respond impulsively. The test consists of an infrared motion analysis systems, which tracks head movement in children (and head plus lower extremity movement in adolescents and adults), while they perform a monotonous but demanding novel Go/No-Go continuous performance attention task. Vertical and horizontal positions of the infrared reflective markers are recorded 50 times per second to a resolution of about 0.04 mm.

FIG. 2A is a plot depicting the estimated plasma levels of d-methylphenidate in children with ADHD during single visit titration protocol, based on number of doses of methylphenidate administered. Circles indicate optimal times for brief M-MAT™ testing to assess response to full range of doses/plasma levels of methylphenidate. FIG. 2B is a flow chart depicting a rapid titration protocol.

FIG. 3 is a scheme depicting an algorithm for using MT scoring to select a dosing regimen based upon the subject's dose-response profile for the probe drug being administered. The titration protocol can optionally include heart rate monitoring to identify subjects at risk of an adverse cardiac response.

FIG. 4 is another scheme depicting an algorithm for using MT scoring to select a dosing regimen based upon the subject's dose-response profile for the probe drug being administered.

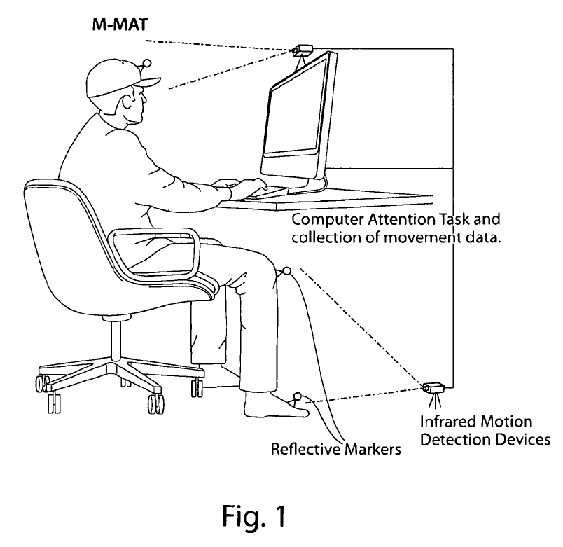

### DETAILED DESCRIPTION

The invention features methods and systems which can provide, in one test session (i.e., in a single day), information on the patient's sensitivity and responsiveness to a probe dose of a medicament. The methods and systems of the invention can enable clinicians and consumers to ascertain how much benefit an individual would derive from a particular pharmacotherapy, what dose would be required, and, optionally, the acute effect of that dose on regularity and rhythmicity of their heartbeat. The development of an effective single-visit titration protocol has the potential to revolutionize clinical practice, and may enable millions of individuals to derive a great degree of benefit from treatment, and may also save some subjects months or years of unnecessary treatment with an agent that provides them with little benefit. The methods of the invention make use of the idea that an oral probe dose of immediate release medicaments (e.g., methylphenidate, Adderall™, dextroamphetamine, atomoxetine) are absorbed fairly rapidly, and are immediately effective once absorbed, so that they will exert noticeable effects on behavior in an hour, and maximal effects at 90-120 minutes post dosing. Because these drugs are eliminated at a somewhat slower rate, they continue to remain effective for 4-6 hours post dosing. Given these properties it is possible to effectively increase blood levels and response by administering doses at 1-2 hour intervals. It is also possible to calculate a subject's response profile based upon the parameters of a population-based PK profile for the probe drug.

The methods and systems of the invention can provide, in one test session, information on the patient's sensitivity and responsiveness to a stimulant. From this response profile, it is possible to mathematically model and predict with reasonable accuracy how the subject would respond to any of the different long acting stimulant preparations (e.g., Concerta™ 18, 36, and 54 mg; Metadate CD™ 20, 40, 60 mg; Ritalin-LA™ 10-60 mg). These predictions can indicate degree of improvement in a subject's capacity to sit still, ability to avoid distraction, and ability to suppress impulsive responses throughout the entire day.

### Systems

The invention consists of a number of parts, including a client software program that runs the protocol. The software program administers a baseline test of behavioral and physiological response, records when a probe dose was given, and records the results of these tests. The software program may also determine when subsequent tests should be given, and determine if an additional probe dose is necessary.

For example, the test itself can consist of a computerized Go/No-Go attention task designed to determine shifts in attentional state (see U.S. Pat. No. 6,685,652) that is coupled to an infrared motion analysis system to record head movements as an index of hyperactivity, and records heart rate as an independent measure of physiological response to the test medication. A server-based system that analyzes the data from the sequential tests, determines sensitivity (dose-response) and time course, and predicts dose requirement and degree of benefit that the individual would likely derive from treatment with available long-acting preparation of the test medication. Alternatively, the data processing can be incorporated into the expert system running the protocol. The latter approach may be preferable as rapid interpretation of tests results is critical to the success of the method.

At the end of the testing, the recorded data (e.g., key press information and movement information) can be processed by a local computer or transmitted over a computer network to a central station for processing. A report can be generated at the testing site, or at the site of remote processing. Such a report may be in a paper form, electronic form, or stored in a database as part of the subject's medical records. The report can include one or more of the following: (i) the unmedicated and medicated results for one or more metrics, or a composite thereof, for a test subject; (ii) the results obtained for a subject and the range of results observed for normal subjects given the subject's gender, age, and/or grade; (iii) the classification of a subject as a non-responder, a partial responder, or a responder; (iv) a predicted response profile for the subject given a particular dosing regimen of a drug; (v) the predicted degree of improvement in a symptom of an attentional disorder for the subject given a particular dosing regimen of a drug; (vi) the relative degree of efficacy predicted for two or more dosing regimens of a drug for a given test subject; (vii) the observed or predicted adverse side effects (e.g., a cardiovascular event, nervousness, agitation, or loss of appetite) for a subject receiving a particular amount or dosing regimen of drug; (viii) the unmedicated and medicated heart rate data for a test subject; (ix) the identity of the drug used in the test; (x) the timing of the doses administered to the subject; and/or (xi) the timing of the tests administered to the subject.

### Motion Detection System

A motion detection system can be used to track the movement of the head an/or lower extremities of the individual receiving a motor activity test. Movement patterns are analyzed using procedures described by Teicher et al., J. Am. Acad. Child Adolsec. Psychiatry 35:334 (1996), which are based on the concept of microevents. A new microevent begins whenever the marker moves more than a predetermined distance (e.g., 1.0 mm or more) from the location of the previous microevent, and is defined by its position and duration. From the sequence of microevents, the mean locomotor path length can be calculated, along with two scaling exponents.

The first exponent, the spatial scaling exponent, is a measure of the complexity of the movement and is calculated by ascertaining the logarithmic rate of information decay at progressively lower levels of resolution. Conceptually, if a marker is still or moving in a straight line, no information is lost if the marker's position is sampled less frequently. The total distance traversed can still be calculated. On the other hand, if a marker is moving in a convoluted path, then less frequent sampling smooths out the route and underestimates the distance traveled. Spatial complexity corresponds to the concept of fractal dimensions and ranges from 1.0 (straight line movement) to 2.0 (complex, convoluted movement patterns).

The other exponent, known as the temporal scaling exponent, is calculated from the log-log relationship between the frequency of the microevents and their duration. For a two-process model in which a marker is either in motion or immobile, stochastic theory dictates that there will be a greater number of brief periods of immobility than long periods of immobility (though not necessarily a greater amount of time). The log-log relationship provides a robust measure of relative activity versus inactivity and indicates the degree to which a subject is moving in the environment.

Any video camera or other motion-sensing device capable of detecting the movements of the test subject can be used. For example, the motion analysis device can be an infrared motion analysis system (e.g., Qualisys, Glastonbury, Conn.) that includes a high-resolution CCD infrared video camera, an infrared strobe, and a video processor that provides hardware analysis of the video signal and outputs data to a computer. Such infrared motion analysis systems are known in the art, and are specifically designed to detect and record the precise vertical and horizontal position of small, light-weight infrared reflective markers. These markers are attached to the subject at various points, such as the head, shoulders, arms, legs, and feet. As the subject moves these portions of his or her body, the IR motion analysis system detects changes in the positions of the markers and relays this information to a computer. Successive marker coordinates can be stored in the computer and analyzed using commercially available software (e.g., M-MAT™ software). Desirably, the camera is positioned in front of the subject, who is preferably in a seated position. The camera is also desirably positioned in such a manner that it can capture movements of the reflective markers in three dimensions, including movements towards and away from the display device. The motion analysis device can also include a second camera that can be used in combination with the first camera to better differentiate three dimensional movement. Adults with ADHD can manifest hyperactivity solely through excess movement of their lower extremities while seated. Therefore, the first camera can be used to track the movement of the subject's legs and/or feet or a second camera can be used to track the movement of the subject's lower extremities while the first camera tracks upper body movements.

### Attentional Testing

The attentional testing includes a cognitive control task, such as a continuous performance test (CPT), the results of which are diagnostic of physiological response to medication. For example, a subject's visual attention can be tested by displaying a series of visual stimuli, to which the subject is instructed to respond. Typically, the stimuli are of two types, and the subject is instructed to respond to only one of them. Data are collected for each stimulus presented including the type of stimulus, whether or not the subject responded, and if so, how long the subject took to respond. The continuous performance attention test has been in use since the mid 50's (Rosvold et al., J. Consulting and Clinical Psychology 20:343 (1956)), with computerized versions available in the 1970's (Greenberg, Psychopharmacol. Bull. 23:279 (1987)).

The CPT results can include measuring errors of commission, errors of omission, and mean correct reaction time with standard deviation. More sophisticated CPT measures, derived from signal detection theory can include a calculation of stimulus sensitivity (d′) (see, for example, Nuechterlein, J. Abnorm. Psychol. 92:4 (1983)).

Analysis of the CPT results can also include assessing the pattern or fluctuation in attentional states by a subject during a test period. This approach is described in U.S. Pat. No. 6,685,652, incorporated herein by reference.

The methods of the invention may be used alone, together, or in conjunction with other well-known psychological tests for determining attention or reaction time. Testing of the subject's performance may be conducted with or without providing corrective feedback to the subject during performance of the CPT.

### Heart Rate

The methods and systems of the invention can include the measurement and analysis of heart rate to assess enhanced risk of adverse cardiovascular events in a subject.

Standard measures of heart rate variability found useful in the prediction of susceptibility to sudden death or life-threatening arrhythmias include standard deviation, or coefficient of variation, of R-R intervals (see, for example, Kataoka et al., Diabetes Res. Clin. Pract. 64:51 (2004); and Molgaard et al., Clin. Auton. Res. 1:233 (1991)), amount of total or relative power in the low-frequency spectral band (see, for example, Cohen et al., Br. J. Psychiatry 179:167 (2001); and Galinier et al., Eur. Heart J. 21:475 (2000)), or a non-linear measure from symbolic dynamics such as WPSUM13 (see, for example, Schumann et al., Stat. Med. 21:2225 (2002)), which indicates the number of beat-to-beat intervals (BBIs) that deviate from the mean BBI by >20 msec (Voss et al., Cardiovasc. Res. 31:419 (1996)).

Several patents have been issued that describe more mathematically sophisticated means of analyzing heart rate variability (such as multifractal analysis), specifically to predict risk of adverse cardiac events in medical populations at acute risk (see, for example, U.S. Pat. Nos. 6,993,377; 6,980,851; 6,731,974; 6,487,442; 6,454,707; 6,308,094; 5,967,995; 5,265,617; and 5,201,321), and/or to detect preexisting heart disease (see, for example, U.S. Pat. Nos. 6,993,377; 6,936,010; 6,638,232; and 6,148,228). The basic techniques for use of heart rate variability power spectrum in assessment of cardiovascular regulation is described in U.S. Pat. Nos. 4,862,361; and 4,832,038. Each of the above patents is incorporated herein by reference.

The methods and systems of the invention can include, based upon heart rate data, determining whether a subject is at risk of an adverse cardiac event if prescribed a particular medicament, or dosing range for a particular medicament.

### Software

The invention can include a software-based system crafted to administer the single-visit titration protocol of the invention. The computerized tool will guide clinicians through the protocol and provide time accuracy for administering medication as well as testing, both of which are crucial to the success of the protocol. The software-based system can also provide a reliable evaluation of the test results. The software will take the complexity out of the system interface, and will control it by careful design. For example, the protocol flowchart can be converted into a Java program, including each decision node of the flowchart, with entries in a rule database that explains the rationale behind each recommendation made by the system.

### Therapy and Dosing Regimens

The methods and systems of the invention can be used to identify an efficacious dosing regimen for a medicament used for the treatment of an attentional disorder, such as ADHD. Both stimulant and non-stimulant medicaments can be used in the methods of the invention.

### Stimulant Medicaments

Central nervous system stimulants, such as MPH, are used in the treatment of Attention Deficit Disorder (“ADD”), a commonly diagnosed nervous system illness in children that is characterized by both distractability and impulsivity, Attention Deficit Hyperactivity Disorder (“ADHD”), in which symptoms of hyperactivity are present along with the symptoms of ADD, and can also decrease symptoms related to co-existing conditions, such as Oppositional Defiant Disorder. Stimulants are also used in the symptomatic treatment of narcolepsy, depression, and the cognitive decline associated with Acquired Immunodeficiency Syndrome (“AIDS”) or AIDS-related conditions, as well as for mood elevation, particularly in terminally ill patients with diseases such as cancer.

Immediate Release Methylphenidate Preparations Immediate release (IR) methylphenidate comes in brand (Ritalin) and generic (methylphenidate) formulas. IR methylphenidate begins working almost immediately (within about 20 to 30 minutes) and lasts 3 to 4 hours. The scored tablets come in 5, 10, and 20 mg scored formulations. The maximum recommended daily dose is 60 mg. Methylphenidate administered three times a day dosing was found to be more effective that twice a day dosing in the MTA study.

Focalin is the d-isomer of methylphenidate, the active isomer in regular methylphenidate which is a racemic mixture of both d and 1 isomers. Focalin is twice as potent as methylphenidate, e.g. 2.5 mg of Focalin has the same therapeutic benefit as 5.0 mg of Ritalin. Focalin begins working immediately and lasts 3 to 4 hours. The recommended starting dose for new patients is 2.5 mg twice daily. Focalin tablets come in 2.5, 5 and 10 mg formulations. The maximum recommended daily dose is 20 mg (10 mg twice daily).

### Sustained Release Methylphenidate Formulations

Concerta™

Concerta™ has been available since August 2000. Concerta™ is a capsular version of methylphenidate. IR methylphenidate coats the surface of the capsule and an OROS™ delivery system uses osmotic pressure to pump methylphenidate out of the capsule over the course of the day. Only 22% of the medication is released upon ingestion; the delivery system pumps the remaining 78% of the medication out over 8 to 12 hours. Concerta™ lasts up to 12 hours, providing smooth control without school dosing, and has not associated in the literature with a higher incidence of rebound or insomnia. Concerta™ is currently available in 18 mg, 27 mg, 36 mg, and 54 mg coated capsules that may not be broken or chewed because of the presence of the pump inside the capsule. The recommended maximum daily dose is 54 mg.

Metadate CD™

Metadate CD™ was approved in March 2001 by the FDA as an extended-release methylphenidate capsule. This medication uses a unique method of controlled drug delivery called Diffucaps™. This system uses beads inside the capsule that are released in two main “waves”. Approximately 30% of the dose is released immediately and 70% of the dose is available for extended release. The first peak plasma level is achieved about 1.5 hours after dose and the second peak plasma level is reached about 4.5 hours after dosing. Metadate CD™ comes 20 mg capsules. The maximum recommended daily dose is 60 mg.

### Metadate ER™

Metadate ER™, a form of methylphenidate, is available as extended-release tablets of 10 and 20 mg and is more slowly but as extensively absorbed as in the regular tablets. Metadate ER™ tablets have a duration of action of approximately 8 hours. The maximum recommended daily dose is 60 mg.

### Methylin ER™

Methylin ER™ was approved by the FDA in May 2000. It is available in 10 mg and 20 mg extended release tablets. It uses a dual-acting hydrophilic polymer release technology, where the release of methylphenidate is due to diffusion and erosion. Methylin ER™ is thought to have a duration of action of 4 to 8 hours. The maximum recommended daily dose is 60 mg.

### Ritalin SR™

Ritalin-SR™ (sustained release formula, methylphenidate) has been available for more than a decade. This medication takes effect within an hour after administration and may last for four to eight hours, which theoretically eliminates the need for a second dose to be taken at school. The maximum recommended daily dose is 60 mg.

### Ritalin LA™

Ritalin LA™ is an extended-release formulation of Ritalin that eliminates mid-day dosing. Ritalin LA™ is available in 10, 20, 30 and 40 mg. Ritalin LA™ administers an immediate dose of methylphenidate upon consumption and a second dose approximately 4 hours later. Effects of Ritalin LA™ have a duration of approximately 6-8 hours. The maximum recommended daily dose is 60 mg.

### Daytrana™

Daytrana™, formally known as MethylPatch™, is a medicinal patch marketed by Shire Pharmaceuticals and is most commonly referred to as Methylphenidate Transdermal System (MTS). Daytrana is FDA approved as a once daily treatment of pediatric patients, ages 6 to 12, with Attention Deficit Hyperactivity Disorder. Oral-based methylphenidate pharmaceuticals can be subject to first-pass hepatic metabolism, and the levo-isomer is extensively metabolized, consequently contributing nothing to the dextro-isomer's clinical value. In contrast, Daytrana™ is administered transdermally and avoids most first-pass hepatic metabolism. As a result, the levo-isomer accounts for a thirteenth of Daytrana's efficacy.

### Amphetamine Formulations

Adderall™

Adderall™ is a mixture of amphetamine salts (dextroamphetamine saccharate, dextroamphetamine sulfate, aspartate &I-amphetamine, and sulfate d/l-amphetamine) formulated for immediate release. Adderall is marketed in unit dosage forms of 2.5 mg, 5 mg, 7.5 mg, 10 mg, 12.5 mg, 15 mg, 20 mg, 25 mg, and 30 mg strengths.

Adderall XR™

Adderall XR™ is an extended-release formulation containing a mixture of amphetamine salts. These four amphetamine salts are reported to be metabolized at different rates and to possess diverse half lives, therefore resulting in a less dramatic onset and termination of therapeutic action; as compared to single salt amphetamine preparations. Adderall XR™ is marketed in unit dosage forms of 2.5 mg, 5 mg, 7.5 mg, 10 mg, 12.5 mg, 15 mg, 20 mg, 25 mg, and 30 mg strengths.

VYVANSE™

VYVANSE™ is a therapeutically inactive prodrug, in which d-amphetamine is covalently bonded to 1-lysine, and after oral ingestion it is converted to pharmacologically active d-amphetamine. VYVANSE™ is currently available in dosage strengths of 20 mg, 30 mg, 40 mg, 50 mg, 60 mg, and 70 mg, each for once-daily dosing.

### Nonstimulant Medicaments

Nonstimulant medicaments, such as tricyclic antidepressants (TCAs), alpha2 agonists, bupropion, modafinil, and atomoxetine are prescribed for the treatment of attentional disorders, such as ADHD.

### Atomoxetine

Atomoxetine is the first non-stimulant drug approved for the treatment of attention-deficit hyperactivity disorder (ADHD). It is manufactured and marketed under the brand name Strattera™ by Eli Lilly and Company. Atomoxetine is classified as a norepinephrine reuptake inhibitor, and is approved for use in children, adolescents, and adults. Its advantage over stimulants for the treatment of ADHD is that it has less abuse potential than stimulants, is not scheduled as a controlled substance, and has proven in clinical trials to offer 24 hour coverage of symptoms associated with ADHD in adults and children. Strattera™ is marketed in unit dosage forms of 10 mg, 18 mg, 25 mg, 40 mg, 60 mg, 80 mg, and 100 mg strengths.

### Alpha2 Agonists

Alpha-2 agonists, such as clonidine and guanfacine, exert their therapeutic effects through stimulation of post-synaptic alpha-2A receptors on the dendritic spines of prefrontal cortical pyramidal cells, increasing the functional connectivity of the prefrontal cortical networks, and thus strengthening the regulation of attention and behavior. Clonidine comes in 0.1, 0.2, and 0.3 mg tablets as well as a transdermal patch. The typical daily dose is 0.2 to 0.3 mg per day in three or four divided doses. Guanfacine is given in amounts between 1 mg and 3 mg per day in three divided doses.

### Tricyclic Antidepressants

Tricyclic antidepressants have been shown to be effective in treating attention-deficit hyperactivity disorder. ADHD is thought to be caused, in part, by norepinephrine shortages in the brain's prefrontal cortex. Tricyclic antidepressants block the reuptake of norepinephrine, thus acting as norepinephrine agonists. They are commonly used in patients for whom psychostimulants (the primary medication for ADHD) are ineffective. TCAs are more effective in treating the behavioral aspects of ADHD than the cognitive deficits; they help limit hyperactivity and impulsivity but have little effect on attention. TCAs which can be used include desipramine, imipramine, protriptyline, and nortriptyline.

### Bupropion

Bupropion (Wellbutrin™) is an atypical antidepressant useful for the treatment of symptoms associated with ADHD. Bupropion is a dopamine and norepinephrine reuptake inhibitor. It is about twice as potent an inhibitor of dopamine reuptake than of norepinephrine reuptake.

### Modafinil

Modafinil has been used for the treatment of ADHD, however, modafinil's mechanism of action in ADHD is unknown. It has been proposed that rather than blocking the dopamine transporter, modafinil might activate the anterior cingulate cortex. This, in turn, might affect executive function and alertness in ADHD.

### Single-Visit Titration Protocol

We have designed a single-session titration protocol for children which takes into account the known pharmacokinetics of immediate-release (IR) MPH in adults (Kimko et al., Clin. Pharmacokinet. 37:457 (1999); Srinivas et al., Pharm. Res. 10:14 (1993)). We have found that the following formula provides a robust estimate of individual plasma levels of d-methylphenidate following escalating or pulsatile doses of IR-MPH with r>0.95.

$${Cp}_{T} = \frac{F \cdot ( {dose}_{1} - fp ) \cdot {k}_{a} \cdot [ {e}^{- {k}_{d} ( t - {t}_{1} )} - {e}^{- {k}_{e} ( t - {t}_{1} )} ]}{V \cdot ( {k}_{e} - {k}_{e 1} )} + \frac{F \cdot ( {dose}_{2} - fp ) \cdot {k}_{a} \cdot [ {e}^{- {k}_{d} ( t - {t}_{2} )} - {e}^{- {k}_{a} ( t - {t}_{2} )} ]}{V \cdot ( {k}_{a} - {k}_{e 1} )} … + \frac{F \cdot ( {dose}_{n} - fp ) \cdot {k}_{a} \cdot [ {e}^{- {k}_{e 1} ( t - {t}_{n} )} - {e}^{- {k}_{a} ( t - {t}_{n} )} ]}{V \cdot ( {k}_{a} - {k}_{e 1} )} \qquad Equation 1$$

In equation 1, Cpₜ is the concentration in the plasma at time t, F is the fraction absorbed, dose₁, dose₂ . . . doseₙ are the doses (in mg/kg) administered at each time point, fp is the amount of the dose (in mg/kg) removed by presystemic first-pass metabolism, kₐ is the rate constant for absorption kₑₗ is the rate constant for elimination, t₁, t₂, tₙ are the administration times for each dose, and V is the volume of distribution (in mL/kg).

Using rate constants Kₐ and Kₑₗ of 1.167 and 2.942 hours, respectively yields tₘₐₓ (2.1 hr), t_{1/2} (4.8 hr) and Cₘₐₓ (18.1 μg/L) estimates that are equivalent to those reported by Srinivas (see Srinivas et al., Pharm. Res. 10:14 (1993)) for adults following administration of 40 mg IR-MPH. For adults rate constants of Kₐ=0.95, and Kₑₗ,=4.4 are used.

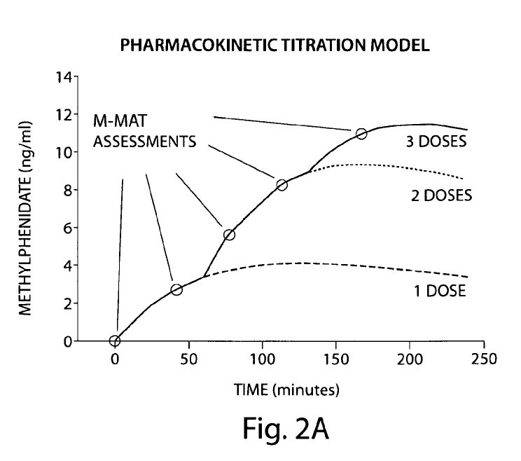

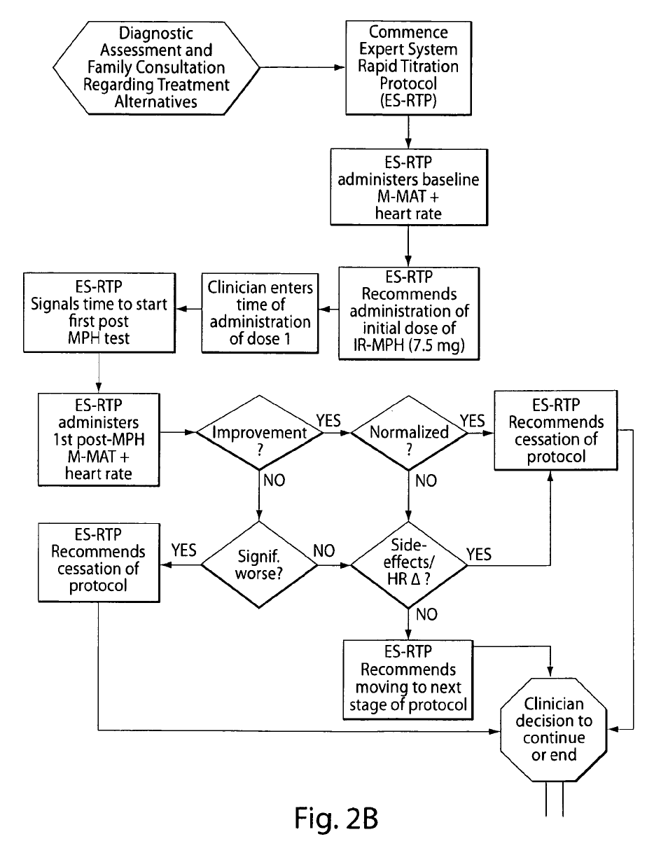

FIG. 2 and Table 1 summarize the details of a proposed rapid titration model, indicating times when probe doses of IR-MPH are administered, and optimal times for brief (5 minute) M-MAT™ tests.

TABLE 1

| | | | | Daily | |
|---|---|---|---|---|---|
| | Dose IR- | Est. MPH | | MPH | |
| Time | MPH | Level | Brief M-MAT | equiv. | OROS-MPH |
| (min.) | (mg) | (ng/mL)¹ | administration | dose | equiv. dose |
| — | — | — | Baseline (MT₀) | | |
| 0 | 7.5 | 0.00 | | | |
| 42 | | 2.70 | test 1 (MT₁) | 12.5 | 18-27 |
| 60 | 10 | 3.32 | | | |
| 78 | | 5.61 | test 2 (MT_{2A}) | 25 | 27-36 |
| 114 | | 8.24 | test 3 (MT_{2B}) | 37.5 | 36-45 |
| 132 | 5 | 8.49 | | | |
| 168 | | 10.93 | test 4 (MT₃) | 50 | 54 |

¹based upon pharmacokinetic model, with Cmax occurring 2.1 hours post administration (tmax), and apparent t½ elimination equal to 4.3 hours, and 40 kg body mass.

In FIG. 2 and Table 1, estimated plasma levels of MPH at each time point represents group mean values, and do not necessarily apply to an individual subject. Indeed, there may be 2-3 fold differences between individuals in peak blood levels (Cmax) of MPH following oral administration of the same mg/kg dose (see, for example, Teicher et al., J. Child Adolesc. Psychopharmacol.16:416 (2006)). However, the goal is not to model an individual's MPH level, but to model their respective Cmax for an equivalent daily dose of a long-acting MPH preparation, such as OROS-MPH (e.g., Concerta™). Hence, a subject who fits the group mean for rates of absorption and elimination would be expected to have a plasma d-MPH level of about 4.8 ng/ml at time of the second M-MAT™ test, and would also be expected to have a Cmax of about 4.8 ng/ml on an OROS-MPH dose of 27 mg. Another individual who metabolizes more slowly might have a plasma d-MPH level of 8 ng/ml during the second M-MAT™, but given their metabolism, they should also have a Cmax of 8 ng/ml on the same 27 mg OROS-MPH dose.

The single-visit titration protocol provides an escalating dose regimen for MPH similar to OROS-MPH with Tmax of 5 hours, versus 6.8 for OROS-MPH. It also provides 3 decision points during dose escalation, to maximize the likelihood that individuals who are highly sensitive to MPH will be recognized early in the protocol and will not go on to receive an excessive dose.

Using the single-visit titration protocols of the invention, the degree of improvement during the first post MPH M-MAT™ test should predict degree of improvement in a subject's everyday life on 18 mg OROS-MPH, the degree of improvement during the second post MPH M-MAT™ test should predict degree of improvement in a subject's everyday life on 27 mg OROS-MPH, and so on. Exact rank-order equivalence is not critical.

The single-visit titration protocol can also accomplish the following: (i) successfully identifies subjects who respond well to IR-MPH and/or OROS-MPH; (ii) successfully identifies subjects who fail to benefit from any dose of IR-MPH and/or OROS-MPH; and (iii) correctly predicts IR-MPH and/or OROS-MPH doses associated with optimal response in those subjects who responded well.

The single-visit titration protocol can also be used to provide a predicted degree of clinical global improvement on a given daily dose of IR-MPH or OROS-MPH. These can include, for example, predicted improvement in specific domains of function such as: school/work and social relationships. Any such predictive associations will be based upon regression equations of post-MPH M-MAT™ measures (or M-MAT™ change scores) developed in the course of collecting clinical data. The predictive relationship between M-MAT response and improvement in specific domains of function is based on clinical trials in which clinical ratings regarding these domains of function are obtained on various treatments and compared to M-MAT tests obtained off treatment and at specific times during the course of treatment.

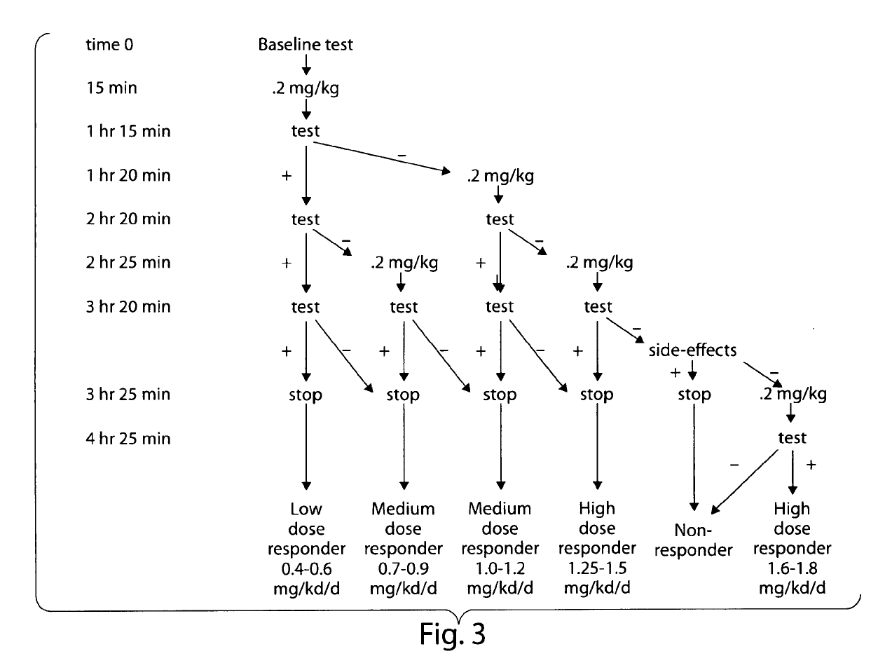

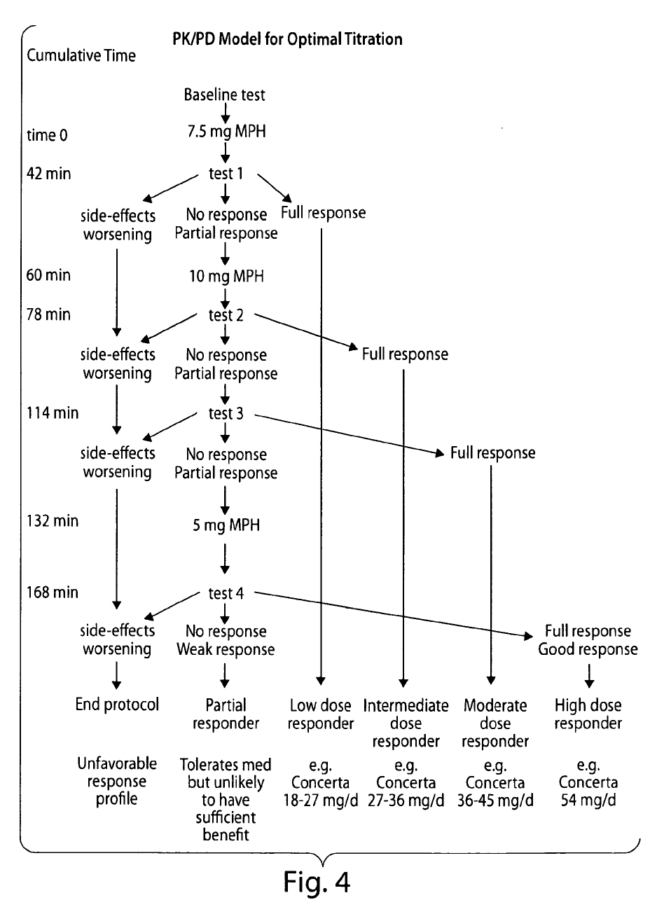

An alternative exemplary single-visit titration protocol of the invention is provided in FIG. 3, which delineates times when M-MAT™ tests would be obtained. Generally, subjects would receive several probe doses of 0.2 mg/kg in the methylphenidate titration paradigm. A subject that required a very high dose to exhibit a response would received a total of four 0.2 mg/kg probe doses (provided they were not experiencing adverse side effects). This single test session can be used to determine whether a subject is a low, medium or high dose responder to a class of drugs. To assess safety, the effect of this drug on their heart rate variability can also be measured. This illustration shows the titration paradigm for methylphenidate-based stimulants. The same procedure can be used with amphetamine-based stimulants using dextroamphetamine as the probe drug, at half of the dose illustrated for methylphenidate.

For example, 0.4 mg/kg methylphenidate, or 0.2 mg/kg dextroamphetamine, are moderately large doses that work well in the single-visit titration protocol. The subject is then retested at 90-120 minutes after ingesting the probe dose (e.g., at the time of peak efficacy). If his level of hyperactivity and inattention are markedly improved (e.g., brought into normal range for the subjects gender, age or grade) then the clinician can identify the subject as a moderate dose responder, and could prescribe accordingly (0.8-1.2 mg/kg/day methylphenidate or 0.4-0.6 mg/kg/day dextroamphetamine, or mixed amphetamine salts). However, if the subject does not show substantial improvement they could either be brought back on a subsequent day to receive a larger probe dose (0.6 mg/kg methylphenidate, 0.3 mg/kg dextroamphetamine), or could receive a second probe dose (0.2-0.3 mg/kg methylphenidate, 0.1-0.15 mg/kg dextroamphetamine) 2 hours after the first probe dose, to ascertain how they respond over the next 60-90 minutes. Conversely, if they experience excessive side-effects on the moderate dose, or show signs of excessive response (too much inhibition of activity), they could be brought back and tested on a lower probe dose, to ascertain if they are low-dose responders.

Alternatively, a probe dose of 0.4 mg/kg methylphenidate is administered to a subject following an unmedicated (baseline) test. The subject is then tested at about 30 minutes post probe and again at about 90 minutes post probe. If the subject responds well at 30 minutes post probe and responds no better or worse at 90 minutes, then we identify that subject as a low-dose responder, who will benefit from a total daily dose of methylphenidate of about 0.4-0.8 mg/kg. If the subject responds better at 90 minutes and has a very robust response (normalizes), then we identify that subject as a moderate dose responder, who will benefit from a total daily dose methylphenidate of about 0.8-1.2 mg/kg. If subject does better at 90 minutes than 30 minutes, but still remains symptomatic, then we identify that subject as a high dose responder who may benefit from 1.2 mg/kg up to a maximum recommended daily dose of methylphenidate.

Finally, if a test subject fails to show substantial benefits on one class of stimulants (i.e., methylphenidate versus amphetamine derivatives, such as dextroamphetamine or Adderall), the subject can be tested on a separate day on a drug from the other class of stimulants. Clinical research has shown that patients with ADHD often respond better to one class of stimulants than another, and that a significant number of patients with ADHD will have a very beneficial response to one class of agents but will fail to respond to the other class, or will have side-effects on only one class (see, for example, Elia et al., Psychiatry Res. 36:141 (1991)).

### Other Embodiments

All publications, patents, and patent applications mentioned in this specification are herein incorporated by reference to the same extent as if each independent publication or patent application was specifically and individually indicated to be incorporated by reference.

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains and may be applied to the essential features hereinbefore set forth, and follows in the scope of the claims.

Other embodiments are within the claims.

What is claimed is:

1. A method for measuring the responsiveness of a subject to a probe drug for the treatment of an attentional disorder in said subject, said method comprising:
(a) testing said subject while unmedicated to produce baseline data for test MT₀;
(b) following step (a), administering a first dose of probe drug to said subject;
(c) within two hours of performing step (b), testing said subject to produce medicated data for test MT₁;
(d) following step (c), administering a second dose of probe drug to said subject;
(e) within two hours of performing step (d), testing said subject to produce medicated data for test MT₂; and
(f) analyzing said data, wherein the analysis comprises scoring said baseline data and said medicated data to produce scored data; and on the basis of said scored data determining whether the symptoms of said attentional disorder are ameliorated by said probe drug,
wherein steps (a) through (e) are performed over a period of less than eight hours.

2. A method for measuring the responsiveness of a subject to a probe drug for the treatment of an attentional disorder in said subject, said method comprising:
(a) testing said subject while unmedicated to produce baseline data for test MT₀;
(b) following step (a), administering a first dose of probe drug to said subject;
(c) within two hours of performing step (b), testing said subject to produce medicated data for test MT₁;
(d) following step (c), administering a second dose of probe drug to said subject;
(e) within two hours of performing step (d), testing said subject to produce medicated data for test MT₂; and
(f) transmitting said data to a computer for analysis, wherein said analysis comprises scoring said baseline data and said medicated data to produce scored data; and on the basis of said scored data determining whether the symptoms of said attentional disorder are ameliorated by said probe drug,
wherein steps (a) through (e) are performed over a period of less than eight hours.

3. A method for measuring the responsiveness of a subject to a probe drug for the treatment of an attentional disorder in said subject, said method comprising:
(i) providing data having been collected by the steps of:
(a) testing said subject while unmedicated to produce baseline data for test MT₀;
(b) following step (a), administering a first dose of probe drug to said subject;
(c) within two hours of performing step (b), testing said subject to produce medicated data for test MT₁;
(d) following step (c), administering a second dose of probe drug to said subject; and
(e) within two hours of performing step (d), testing said subject to produce medicated data for test MT₂,
wherein steps (a) through (e) are performed over a period of less than eight hours; and
(ii) performing an analysis, said analysis comprising scoring said baseline data and said medicated data to produce scored data, and on the basis of said scored data determining whether the symptoms of said attentional disorder are ameliorated by said probe drug.

4. The method of claim 1, wherein
i. step (c) is performed within 1 hour of performing step (b);
ii. step (e) is performed within 1 hour of performing step (d); and
iii. steps (a) through (e) are performed over a period of less than six hours.

5. The method of claim 1, wherein step (e) is performed twice within two hours of performing step (d) to produce medicated data for tests MT_{2A} and MT_{2B}.

6. The method of claim 1, further comprising the steps of
(d2) following step (e), administering a third dose of probe drug to said subject; and
(e2) within two hours of completing step (d2), testing said subject to produce medicated data for test MT₃.

7. The method of claim 6, wherein
iv. step (c) is performed within 1 hour of performing step (b);
v. step (e) is performed within 1 hour of performing step (d);
vi. testing the subject within 1 hour of administering said third dose; and
vii. steps (a) through (e2) are performed over a period of less than six hours.

8. The method of claim 6, wherein step (e2) is performed twice within two hours of performing step (d2) to produce medicated data for tests MT_{3A} and MT_{3B}.

9. The method of claim 6, further comprising the steps of:
(e3) following step (e2), administering a fourth dose of probe drug to said subject; and
(d3) within one hour of completing step (e3), testing said subject to produce a medicated data for test MT₄;
wherein steps (a) through (d3) are performed over a period of less than eight hours.

10. The method of claim 9, wherein step (d3) is performed twice within two hours of performing step (e3) to produce medicated data for tests MT_{4A} and MT_{4B}.

11. The method of claim 1, wherein said probe drug is a stimulant.

12. The method of claim 11, wherein said probe drug is methylphenidate.

13. The method of claim 12, wherein said subject is an adult, said first dose comprises from 5 to 15 mg of methylphenidate, said second dose comprises from 7.5 to 12.5 mg of methylphenidate, and said third dose comprises from 2.5 to 12.5 mg of methylphenidate.

14. The method of claim 13, wherein said first dose comprises 7.5 mg of methylphenidate, said second dose comprises 10 mg of methylphenidate, and said third dose comprises 5 mg of methylphenidate.

15. The method of claim 12, said subject is a child, said first dose comprises from 2.5 to 12.5 mg of methylphenidate, said second dose comprises from 5 to 7.5 mg of methylphenidate, and said third dose comprises from 1.5 to 7.5 mg of methylphenidate.

16. The method of claim 11, wherein said probe drug is an amphetamine.

17. The method of claim 16, wherein said subject is an adult, said first dose comprises from 2.5 to 7.5 mg of dextroamphetamine, said second dose comprises from 3.75 to 6.25 mg of dextroamphetamine, and said third dose comprises from 3.75 to 6.25 mg of dextroamphetamine.

18. The method of claim 16, wherein said subject is a child, said first dose comprises from 1.25 to 6.25 mg of dextroamphetamine, said second dose comprises from 2.5 to 3.75 mg of dextroamphetamine, and said third dose comprises from 0.75 to 3.75 mg of dextroamphetamine.

19. The method of claim 1, wherein said probe

[symbol]

20. The method of claim 18, wherein said probe drug is a tricyclic antidepressant, atomoxetine, bupropion, modafinil, guanfacine, or clonidine.

21. The method of claim 1, wherein said analysis further comprises identifying said subject as a non-responder or a responder.

22. The method of claim 1, wherein said analysis further comprises calculating a predicted response profile for a dosing regimen of said probe drug in said subject.

23. The method of claim 22, wherein said analysis further comprises the step of calculating the predicted degree of improvement in a symptom of said attentional disorder for said subject when receiving said dosing regimen in comparison to said subject when unmedicated.

24. The method of claim 22, wherein said analysis further comprises the step of determining the relative degree of efficacy for two or more dosing regimens of said probe drug in said subject.

25. The method of claim 1, wherein said analysis further comprises:
(i) analyzing the heart rate of said subject to determine whether said probe drug places the subject at an increased risk of an adverse cardiovascular event, or
(ii) analyzing solicited responses from the subject to determine whether said probe drug places the subject at an increased risk of nervousness, agitation, or loss of appetite.

26. The method of claim 25, wherein said analysis further comprises estimating the severity of the side effects for said subject on a particular dosing regimen of said probe drug. estimating the severity of the side effects for said subject on a particular dosing regimen of said probe drug.

27. The method of claim 1, wherein said attentional disorder is ADD, ADHD, or Hyperkinetic Disorder.

28. The method of claim 1, wherein said testing comprises measuring the activity of said subject using an infrared motion analysis system by tracking the movements of said subject's head, leg, or foot using a camera.

29. The method of claim 1, wherein said testing comprises collecting data from an attentional test.

30. The method of claim 29, wherein said analysis comprises assessing the fluctuation in attentional states of said subject.

31. A system for measuring the responsiveness of a subject to a probe drug for the treatment of an attentional disorder, said system comprising:
(i) a user interface for communicating the amounts of probe drug administered to said subject; the timing of the doses; and the timing of motor activity tests;
(ii) a camera for tracking the movements of said subject's head, leg, or foot to produce motor activity data; and
(iii) an output component and program configured to transmit information to a computer for analysis, said information comprising the amounts of probe drug administered to said subject; the timing of the doses; the timing of the motor activity tests; and the motor activity data.

32. A system for measuring the responsiveness of a subject to a probe drug for the treatment of an attentional disorder, said system comprising:
a monitor for generating visual images or a speaker for generating sounds;
(ii) a device that is controllable by a subject; and
(iii) a program for storing or transmitting information about the instances of device activation by said subject in response to said images or said sounds to a computer for analysis, said information comprising attention data and the timing of the collection of the attention data.

33. A system for measuring the responsiveness of a subject to a probe drug for the treatment of an attentional disorder, said system comprising:
an input component configured to receive information comprising the amounts of probe drug administered to said subject; the timing of the doses; the timing of subject testing; and test data; and
(ii) a processor provided with a computer program for (a) scoring said motor activity data to produce scored data, and (b) on the basis of said scored data, determining whether said subject is responsive to said probe drug.

34-44. (canceled)

45. The method of claim 1
wherein the analysis comprises scoring said baseline data and said medicated data to produce scored data; and on the basis of said scored data, the amount of probe drug administered, the timing of said administering, the timing of said testing, and a population-based PK model for said probe drug, calculating a predicted response profile for said probe drug in said subject.

46-55. (canceled)

56. The method of claim 1, wherein said scored data comprises a metric extracted from an attentional test and selected from accuracy, errors of omission, errors of commission, latency, standard deviation of latency, coefficient of variation of latency, number of attention shifts, percent time spent impulsive state, percent time spent in distracted state, percent time spent in random state, percent time spent in minimal response state, percent time spent in contrary response state, percent time spent in attentive state, accuracy-adjusted latency, and composites thereof.

57. The method of claim 1, wherein said scored data comprises a metric extracted from a motor activity test and selected from immobility time of head, area of head movements, temporal scaling exponent, displacement, spatial scaling exponent, number of microevents, area of right and left shin movements, rl_mic, rl_disp, and composites thereof.

58-59. (canceled)
